(19) United States
(12) Patent Application Publication
(10) Pub. No.: US 2024/0193237 A1
(43) Pub. Date: Jun. 13, 2024

(54) OPERATING SYSTEM CONFIGURATION AND REGISTRATION WITHOUT MANUAL USER INPUT OR INTERACTION AT COMPUTING DEVICE

(71) Applicant: Hewlett-Packard Development Company, L.P., Spring, TX (US)

(72) Inventors: Rosilet Retnamoni Braduke, Spring, TX (US); Wei Ze Liu, Spring, TX (US); Rajesh Shah, Spring, TX (US)

(21) Appl. No.: 18/554,562

(22) PCT Filed: Apr. 16, 2021
(86) PCT No.: PCT/US2021/027673

§ 371 Date: Oct. 9, 2023

(51) Int. Cl. G06F 21/31; G06F 9/4401

(52) U.S. Cl. CPC G06F 21/31; G06F 9/4406

(57) ABSTRACT

A computing device includes a storage device storing an operating system, and a secure storage device storing previously user-provided configuration information for the operating system, a username, and a security token. The computing device includes a processor, and a memory storing instructions executable by the processor. The instructions are executable to, at first user power-on of the computing device, automatically configure the operating system according to the previously user-provided configuration information so that the operating system is configured without manual user input at the computing device. The instructions are executable to automatically register the operating system with the username and with the security token as a single-use password without user interaction.

### BACKGROUND

Computing devices used by end users include desktop, laptop, and notebook computers, as well as smartphones, tablet computing devices, and other types of computing devices. A computing device generally includes an operating system, which is the computer program that manages hardware and software resources, and provides common services for other computer programs running on the computing device. Before a user can use a computing device for the first time, therefore, an operating system usually has to be installed and configured on the computing device.

### BRIEF DESCRIPTION OF THE DRAWINGS

FIG. 1 is a diagram of examples stages in relation to which automatic configuration and registration of a computing device's operating system without manual user input or interaction at the computing device can be provided.

FIG. 2 is a diagram of example automatic configuration and registration of a computing device's operating system without manual user input or registration at the computing device.

FIG. 3 is a diagram of an example non-transitory computer-readable data storage medium storing program code to acquire configuration and other information in accordance with which a computing device's operating system can be subsequently automatically configured and registered without manual user input or interaction at the computing device.

FIG. 4 is a flowchart of an example method for storing, on a secure storage device of the computing device, previously user-provided configuration and other information for automatically configuring and registering the operating system of a computing device, prior to providing the computing device to a user.

FIG. 5 is a diagram of an example computing device that can have its operating system automatically configured and registered according to previously user-provided configuration and other information stored on a secure storage device of the computing device, without manual user input or interaction at the computing device.

### DETAILED DESCRIPTION

Before a user can use a computing device for the first time, the operating system of the computing device has to be installed and configured. For instance, when the user powers on the computing device for the first time, the user may have to input configuration information such as the geographic region in which the user is using the computing device, the language in which the computing device is to be used (English, Spanish, Mandarin, and so on), and the keyboard layout of the computing device (US, UK, and so on). The user may also have to input the name of the wireless network with which the computing device is to connect, as well as the password for this network. The user may further provide a username, such as an email address, and a password for registering the operating system and thus by which the user will subsequently log onto the operating system.

Such initial configuration and registration of the computing device's operating system can be laborious. Not all the information may be solicited from the user at the beginning of the configuration and registration process. Rather, the user may be prompted for the information over a period of extend that can exceed 10, 20, 30, or more minutes, as the operating system is installed, updated, and/or configured. For example, once the wireless network information has been received, the operating system may proceed to acquire and install operating system updates, and may reboot one or multiple times, before other information is requested from the user. The user, therefore, cannot simply turn on the computing device and walk away until operating system configuration and registration have been completed, but rather must attend to the computing device throughout this process until the device is ready for use.

Techniques described herein ameliorate these and other issues. A computing device includes a secure storage device storing previously user-provided configuration for the operating system, a username, and a security token. At first user power-on of the computing device, the operating system of the computing device is automatically configured according to the previously user-provided configuration information without manual user input of such information at the computing device. The operating system is automatically registered with the username and the security token without user interaction, where the security token serves as a single-use password for logging into the operating system.

Therefore, the first time the user powers on the computing device, the user can simply walk away from the device instead of having to attend to the computing device while configuration and registration of the operating system occur. When the user returns after configuration and registration have been completed, the user may encounter the operating system presenting a login screen at which the user can enter the username and an operating system password. Responsive to the user entering the username and the security token (the latter serving as the operating system password), the operating system may prompt the user to change the operating system password to something else. After this user does this, the user can begin using the computing device. The initial operating system configuration and registration process thus occurs with reduced user inconvenience.

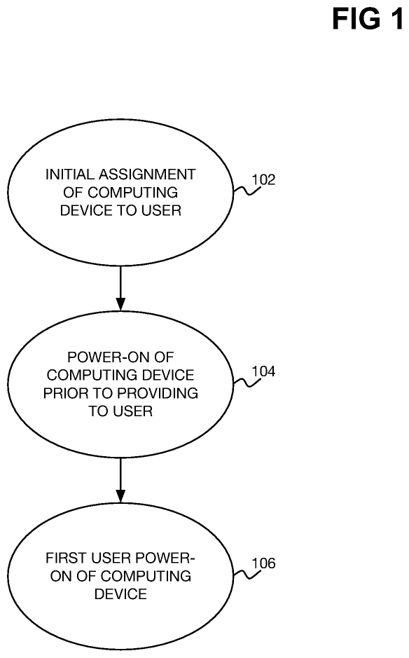

FIG. 1 shows the three example stages 102, 104, and 106 in relation to which the techniques described herein can provide automatic configuration and registration of a computing device's operating system without manual input or interaction at the computing device. The first stage 102 corresponds to initial assignment of the computing device to a user, prior to the user being provided the device. For example, in an enterprise environment the first stage 102 may occur when the user is being assigned a new computer, and has logged into a web site to provide configuration and other information for the new computer's operating system prior to receiving the new computer. As another example, in a home environment the first stage 102 may occur when the user has purchased a new computer online via a web site, and as part of this process provides configuration and other information for the new computer's operating system. In both these examples, the first stage 102 can thus occur incident to a procurement process initiated by the user in relation to the computing device.

The second stage 104 occurs after the first stage 102 has been completed, and corresponds to power-on of the computing device before the computing device is provided to the user. For example, in an enterprise environment the second stage 104 may occur when the computing device assigned to the user has been turned on by an administrator or another user other than the user to which the computing device has been assigned, to store the previously user-provided configuration and other information on a secure storage device of the computing device. As another example, in a home environment the second stage 104 may occur when the computing device is turned on at the factory at which the computing device is being manufactured or otherwise prepared for shipment or delivery to the user, to store the previously user-provided configuration and other information on a secure storage device of the computing device. The second stage 104 thus occurs prior to the user being provided the computing device.

The third stage 106 occurs after the second stage 104 has been completed, and corresponds to the first time the user powers on the computing device upon the user having been provided the computing device. For example, in both an enterprise environment and a home environment, the third stage 106 may occur once the user has received the computing device and has turned the device on for the first time. In the third stage 106, the operating system of the computing device is automatically configured and registered using the previously user-provided information stored on the computing device's secure storage device, without user input of this information at the computing device and without user interaction. After the user initiates power-on for the first time, therefore, the user does not have to attend to the computing device to configure and register the operating system.

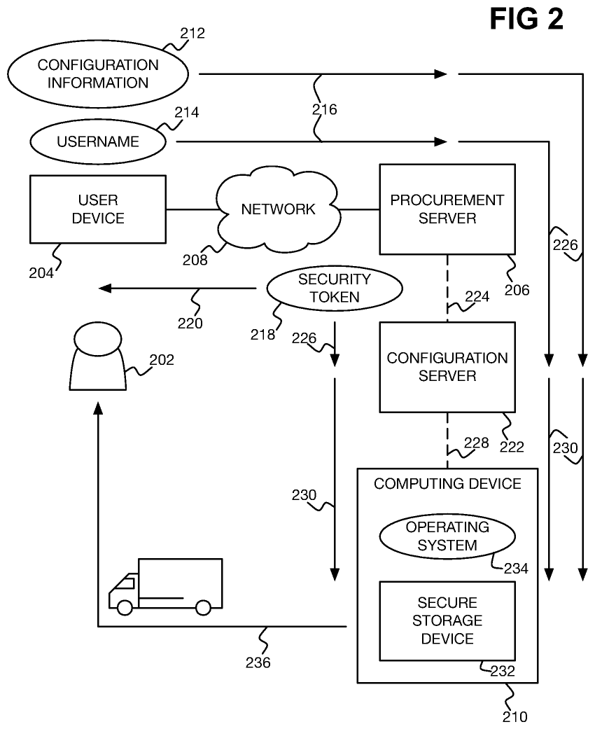

FIG. 2 illustratively shows example automatic configuration and registration of a computing device's operating system without manual user input or interaction at the computing device. A user 202 has an existing user device 204, which may be a computing device like a desktop, laptop, or notebook computer, a smartphone, a tablet computing device, or another type of computing device. The user device 204 is communicatively connected to a procurement server 206 via a network 208. The procurement server 206 may be, for instance, an electronic commerce server by which the user 202 can purchase a new computing device 210, a corporate server by which the user 202 can obtain the new computing device 210 in the context of the user 202's employment, and so on. The network 208 may be or include the Internet, an intranet, an extranet, a local-area network (LAN), a wide-area network (WAN), a wired network, a wireless network, and so on.

The computing device 210 can be assigned to the user incident to the procurement process initiated by the user 202 in relation to the computing device 210 via communicating with the procurement server 206 over the network 208 using the existing user device 204. The procurement server 206 prompts the user for configuration information 212 in accordance with which an operating system 234 of the computing device 210 is to be configured at first user power-on of the device 210 upon receipt of the computing device 210 by the user. The procurement server 206 also prompts the user for a username 214 in accordance with which the operating system 234 is to be registered and thus used to log onto the operating system 234.

As noted above, the configuration information 212 can include the geographic region in which the user is using the computing device 210, the language in which the computing device 210 is to be used (English, Spanish, Mandarin, and so on), and the keyboard layout of the computing device 210 (US, UK, and so on). The configuration information 212 can include the name of the wireless network with which the computing device 210 is to connect when received by the user, as well as the password for this network. The configuration information 212 can include other information as well. The username 214 may be in the form of an email address of the user 202 by which the user will subsequently log onto the operating system 234.

The user 202 enters the requested configuration information 212 and username 214 at the user device 204, which transmits the information 212 and the username 214 to the procurement server 206 over the network 208, per arrows 216. The procurement server 206 generates a security token 218, which serves as a single-use or one-time password in accordance with which the operating system 234 of the computing device 210 is to be registered (along with the username 214) at first user power-on of the device 210 upon the user 202 receiving the computing device 210. The security token 218 may be a random string of characters, for instance.

The procurement server 206 transmits the security token 218 to the user 202 via the provided username 214, per arrows 220. For instance, the procurement server 206 may send an email to the username 214 of the user 202 that includes the security token 218. More generally, the procurement server 206 may transmit the security token 218 to the user 202's existing user device 204 over the network 208.

The procurement server 206 is communicatively connected to a configuration server 222, as indicated by dashed line 224. For instance, the procurement server 206 may be communicatively connected to the configuration server 222 by the network 208 or via a different network. The configuration server 222 may be a different server than the procurement server 206, as in the example of FIG. 2, or may be the same server as the procurement server 206.

The procurement server 206 stores the received configuration information 212 and username 214, and the generated security token 218, on the configuration server 222, per arrows 226. The entry of the configuration information 212 and the username 214 by the user 202, the generation of the security token 218 by the procurement server 206, and the storage of the information 212, the username 214, and the security token 218 on the configuration server 222, occur during the first stage 102 of FIG. 1. That is, such entry and storage of the configuration information 212 and the username 214, and such generation and storage of the security token 218, occur during or as part of initial assignment of the computing device 210 to the user 202.

Then, during the power-on of the computing device 210 prior to providing the device 210 to the user—i.e., during the second stage 104 of FIG. 1—the computing device 210 is communicatively connected to the configuration server 222, as indicated by the dashed line 228. At this time, the computing device 210 is caused to retrieve the previously user-provided configuration information 212, the username 214, and the security token 218 from the configuration server 222, per arrows 230. The computing device 210 is further caused to store the retrieved configuration information 212, username 214, and security token 218 to a secure storage device 232 of the computing device 210. Upon such storage, the computing device 210 can be powered down and provided to the user 202, as indicated by arrow 236. For example, the computing device 210 may be shipped to the user 202.

Thereafter, during the first user power-on of the computing device 210—i.e., during the third stage 106 of FIG. 1—the computing device 210 automatically configures its operating system 234 in accordance with the previously user-provided configuration information 212 stored on the secure storage device 232 without manual user input of this information 212 at the device 210 itself. The computing device 210 further automatically registers the operating system with the username 214 and with the security token 218, where the latter serves as a single-use password, without user interaction at the device 210.

The user 202 therefore does not have to attend to the configuration and registration of the operating system 234 during this time, and can instead walk away. When the user 202 returns to the computing device 210 upon completion of such configuration and registration, the user 202 can immediately begin using the device 210 upon entry of the username 214 and the security token 218 as the operating system password, and after changing the password to something different than the token 218 when prompted by the operating system. Therefore, the initial user experience of the computing device 210 is improved, and the computing device 210 is technologically improved insofar as its operating system 234 configuration and registration process is improved.

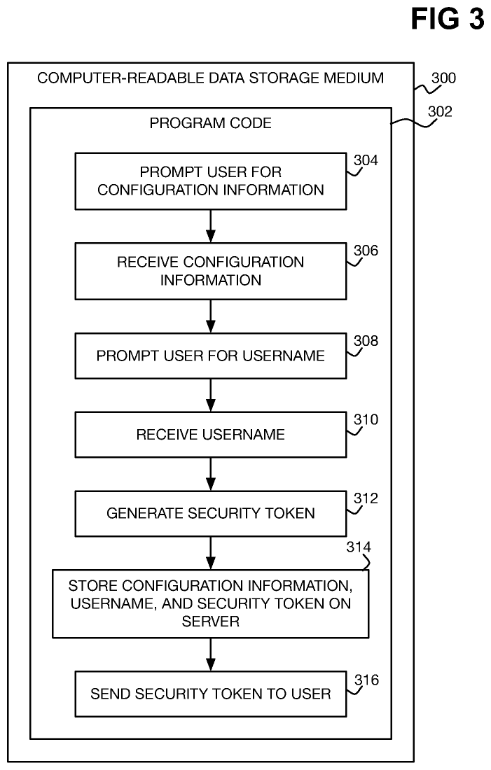

FIG. 3 shows an example non-transitory computer-readable data storage medium 300 storing program code 302 executable by a processor to perform processing to acquire configuration and other information in accordance with which a computing device's operating system can be subsequently automatically configured and registered without user input or interaction at the computing device itself. The processing may be performed in stage 102 of FIG. 1. The processor executing the program code 302 may be part of the procurement server 206 of FIG. 2.

The processing includes, prior to providing a computing device to a user, prompting the user for configuration information in accordance with which an operating system of the computing device is to be automatically configured at first user power-on of the computing device without manual user input at the computing device (304). The processing includes responsively receiving the configuration information from the user (306). The processing includes, also prior to providing the computing device to the user, prompting the user for a username with which the operating system is to be automatically registered at the first user power-on of the computing device without user interaction (308). The processing includes responsively receiving the username from the user (310). The prompting of parts 304 and 308 may be performed incident to a procurement process initiated by the user in relation to the computing device, as has been described above.

The processing includes generating a security token as a single-use password with which the operating system is to be automatically registered at the first user power-on of the computing device without user interaction (312). The processing includes storing the configuration information, the username, and the security token on a server for retrieval by and subsequent storage on the computing device at power-on of the computing device prior to providing the computing device to the user (314). The server on which the configuration information, username, and security token are stored may be the configuration server 222 of FIG. 2. The processing includes sending the security token to the username for entry by the user after configuration and registration of the operating system at the first user power-on of the computing device (316).

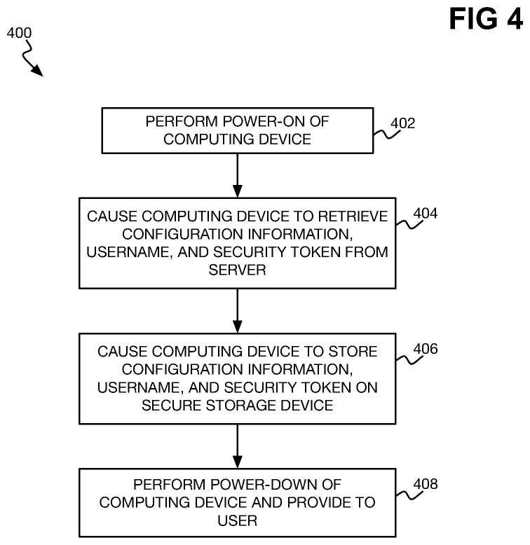

FIG. 4 shows an example method 400 for storing, on a secure storage device of a computing device, previously user-provided configuration and other information for automatically configuring and registering the operating system of the computing device, prior to providing the computing device to a user. The method 400 may be performed in stage 104 of FIG. 1. The method 400 is thus performed after the processing of FIG. 3 has been performed. The method 400 may be implemented at least in part as program code stored on a non-transitory computer program data storage medium and executable by a processor.

The method 400 includes, upon initial assignment of a computing device to a user, performing power-on of the computing device prior to providing the computing device to the user (402). The initial assignment of the computing device may have been achieved incident to a procurement process initiated by the user in relation to the computing device, as has been described. The method 400 includes, upon such power-on of the computing device, causing the computing device to retrieve previously user-provided configuration information, a username, and a security token from a server (404). For example, the computing device may have stored thereon instructions, such that upon power-on of the device, the computing device automatically executes the instructions. The server from which the configuration information, username, and security token are retrieved may be the configuration server 222 of FIG. 2.

The configuration information is that in accordance with which an operating system of the computing device is to be automatically configured at first user power-on of the computing device without manual user input at the computing device. The username is that with which the operating system is to be automatically registered at the first user power-on without user interaction. The security token is that, as a single-use password, with which the operating system is to be automatically registered at the first user power-on without the user interaction.

The method 400 includes responsively causing the computing device to store the previously user-provided configuration information, the username, and the security token that have been retrieved from the server on a secure storage device of the computing device (406). For example, the computing device may have stored thereon instructions such that upon power-on of the device, the computing device automatically executes the instructions after the configuration information, the username, and the security token have been retrieved. The secure storage device may be an endpoint security controller (EpSC) of the computing device. The secure storage device is more generally a storage device that stores the configuration information, the username, and the security token in a secure manner—i.e., in an encrypted or other manner.

The computing device may store the configuration information, the username, and the security token using a management instrumentation service provided by the operating system of the computing device. Such a service may provide an environment-independent specification by which management information can be shared within the computing device. In the context of the MICROSOFT WINDOWS operating system, for instance, the service may be the Windows Management Instrumentation (WMI) service.

The method 400 includes then performing power-down of the computing device and providing the computing device to the user (408). That is, once the configuration information, username, and security token have been stored on the computing device's secure storage device, the computing device can be made ready for providing to the user and then powered down. The computing device may be provided to the user by shipping the device to the user, for instance.

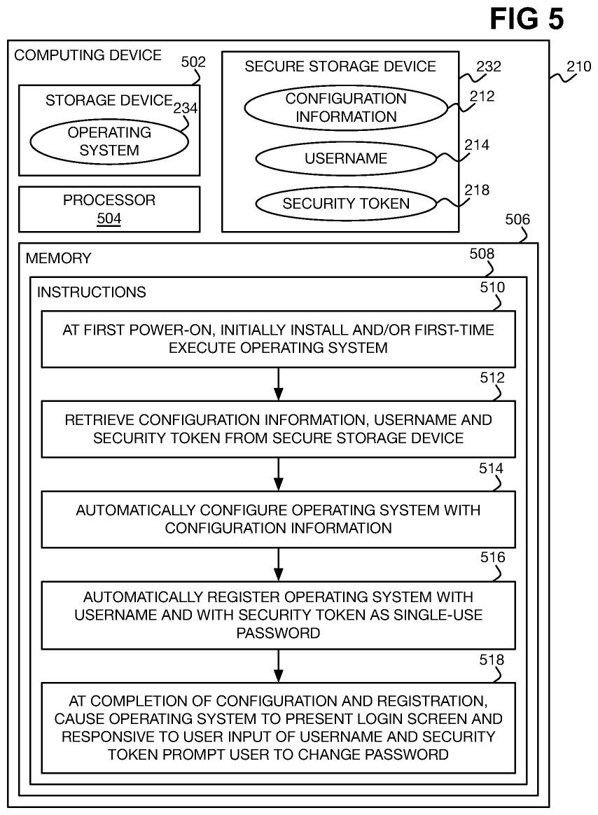

FIG. 5 shows an example computing device 210 that can have its operating system 234 automatically configured and registered without manual user input or interaction at the device 210. The computing device 210 includes a storage device 502 storing the operating system 234, such as a hard disk drive, solid state drive, or another type of storage device. The computing device 210 includes a secure storage device 232, such as an EpSC, storing previously user-provided configuration information 212 for the operating system 234, a username 214, and a security token 218 that were previously stored on the secure storage device 232. The computing device 210 includes a processor 504 and a memory 506 storing instructions 508 executable by the processor 504. The computing device 210 can include other components, in addition to those shown in FIG. 4.

The instructions 508 are executable by the processor 504 at first user power-on of the computing device 210 (i.e., once the computing device 210 has been provided to the user). The instructions 508 are thus executable after the method 400 of FIG. 4 has been performed, and the computing device 210 may have been configured as part of readying the device 210 for providing to the user within the method 400 to execute the instructions 508 the next time the device 210 is powered on (i.e., the first power-on by the user). The instructions 508 are therefore executed in stage 106 of FIG. 1.

The instructions 508 are specifically executed by the processor 504 to, at first user power-on of the computing device 210, initially install and/or first-time execute the operating system 234 (510). For example, when the computing device 210 is readied for providing to the user within the method 400, the operating system 234 may be placed in a partially or completely uninstalled state. Therefore, when the computing device 210 is powered on by the user for the first time, the operating system 234 is installed and subsequently executed. In another implementation, the operating system 234 may not be in a partially or completely uninstalled state, in which case when the computing device 210 is powered on by the user for the first time, the operating system 234 is (just) executed for the first time by the user.

The instructions 508 are executed by the processor 504 to retrieve the previously user-provided configuration information 212, the username 214, and the security token 218 from the secure storage device 232 (512). For example, a management instrumentation service, such as the WMI service in the case of the MICROSOFT WINDOWS operating system, may be used to retrieve the configuration information 212, username 214, and security token 218 from the storage device 232. The instructions 508 may be executed to retrieve the configuration information 212, the username 214, and the security token 218 as part of or during initial installation and/or first-time execution of the operating system 234.

The instructions 508 are executed by the processor 504 to then automatically configure the operating system 234 according to the retrieved configuration information 212 (514), such that the operating system 234 is configured without manual user input of the configuration information 212 at the computing device 210. That is, whereas if the configuration information 212 were not present the operating system 234 would have to prompt the user to enter the information 212, because the configuration information 212 has been retrieved from the secure storage device 232, the operating system 234 does not have to prompt the user in this respect. The instructions 508 may be executed to automatically configure the operating system 234 according to the configuration information 212 as part of or during initial installation and/or first-time execution of the operating system 234.

The instructions 508 are executable by the processor 504 to further automatically register the operating system 234 with the retrieved username 214 and with the retrieved security token 218 (the latter as a single-use password) without user interaction (516). Registration of the operating system 234 in this respect can include creating a user account for usage of the operating system 234, where the user account is associated with the username 214 and with the security token 218 (the latter as a single-use password). Therefore, whereas if the username 214 and the security token 218 were not present the operating system 234 would have to prompt the user for the username 214 and an operating system password to create a user account for usage of the operating system 234, because the username 214 and the security token 218 have been retrieved from the secure storage device 232, user interaction in this respect is avoided. The instructions 508 may be executed to automatically register the operating system 234 using the username 214 and the security token 218 as part of or during initial installation and/or first-time execution of the operating system 234.

The instructions 508 are executable by the processor 504 to, at completion of configuration and registration of the operating system 234, cause the operating system 234 to present a login screen at which a user can enter the username 214 and an operating system password, and responsive to user entry of the username 214 and the security token 218 as the password, prompt the user to change the operating system password (518). That is, once the operating system 234 has been configured and registered, the operating system 234 may be rebooted or otherwise executed in such a way that it can now be used by the user. Therefore, the operating system 234 presents the login screen so that the user can for the first time log into the user account created during operating system 234 registration. Because the security token 218 has been specified as a single-use password during such registration, the user has to enter a new password before he or she can actually use the operating system 234.

Techniques have been described for configuration and registration of an operating system of a computing device without manual user input or interaction at the device. Configuration information and a username instead are received from the user at time of initial assignment of the computing device to the user, before the device has been provided to the user. The configuration information and the username, along with a generated security token that serves as a single-use password for the operating system, are stored in a secure storage device of the computing device prior to providing the computing device to the user. At first user power-on, therefore, the operating system is automatically configured using the stored configuration information and is automatically registered using the stored username and token.

We claim:

1. A computing device comprising:
a storage device storing an operating system;
a secure storage device storing previously user-provided configuration information for the operating system, a username, and a security token;
a processor; and
a memory storing instructions executable by the processor to:
at first user power-on of the computing device, automatically configure the operating system according to the previously user-provided configuration information so that the operating system is configured without manual user input at the computing device; and
automatically register the operating system with the username and with the security token as a single-use password without user interaction.

2. The computing device of claim 1, wherein the instructions are executable by the processor to further:
at the first user power-on of the computing device, first-time execute the operating system on the computing device,
wherein automatic configuration and registration of the operating system occur during first-time execution of the operating system.

3. The computing device of claim 2, wherein the instructions are executable by the processor to further:
at the first user power-on of the computing device, initially install the operating system on the computing device prior to the first-time execution the operating system,
wherein the automatic configuration of the operating system according to the previously user-provided configuration information further occurs during installation of the operating system.

4. The computing device of claim 1, wherein the instructions are executed as part of first-time execution and/or initial installation of the operating system on the computing device.

5. The computing device of claim 1, wherein at completion of automatic configuration and registration of the operating system, the operating system is to:
present a login screen at which a user is to enter the username and an operating system password; and
responsive to user entry of the username and of the security token as the operating system password, prompt the user to change the operating system password.

6. The computing device of claim 1, wherein the instructions are executable to further:
retrieve the previously user-provided configuration information for the operating system, the username, and the security token from the secure storage device.

7. The computing device of claim 6, wherein the previously user-provided configuration information for the operating system, the username, and the security token are retrieved from the secure storage device via a management instrumentation service provided by the operating system.

8. The computing device of claim 1, wherein the secure storage device comprises an endpoint storage controller.

9. A method comprising:
upon initial assignment of a computing device to a user, performing power-on of the computing device prior to providing the computing device to the user;
upon the power-on of the computing device, causing the computing device to retrieve, from a server:
previously user-provided configuration information in accordance with which an operating system of the computing device is to be automatically configured at first user power-on of the computing device without manual user input at the computing device;
a username with which the operating system is to be automatically registered at the first user power-on without user interaction; and
a security token as a single-use password with which the operating system is to be automatically registered at the first user power-on without the user interaction;
responsively causing the computing device to store the previously user-provided configuration information, the username, and the security token that have been retrieved from the server on a secure storage device of the computing device; and
performing power-down of the computing device and providing the computing device to the user.

10. The method of claim 9, wherein the computing device is caused to retrieve, from the server, the previously user-provided configuration information, the username, and the security token via the computing device automatically executing instructions upon the power-on of the computing device.

11. The method of claim 9, wherein the computing device is responsively caused to store the previously user-provided configuration information, the username, and the security token that have been retrieved from the server on the secure storage device via the computing device automatically executing instructions upon the power-on of the computing device.

12. The method of claim 11, wherein the computing device stores the previously user-provided configuration information, the username, and the security token that have been retrieved from the server on the secure storage device via a management instrumentation service provided by the operating system.

13. The method of claim 9, wherein the computing device is initially assigned to the user incident to a procurement process initiated by the user in relation to the computing device.

14. A non-transitory computer-readable data storage medium storing program instructions executable by a processor to perform processing comprising:
prior to providing a computing device to a user, prompting the user for, and responsively receiving from the user, configuration information in accordance with which an operating system of the computing device is to be automatically configured at first user power-on of the computing device without manual user input at the computing device;
prior to providing the computing device to the user, prompting the user for, and responsively receiving from the user, a username with which the operating system is to be automatically registered at the first user power-on of the computing device without user interaction;
generating a security token as a single-use password with which the operating system is to be automatically registered at the first user power-on of the computing device without user interaction;
storing the configuration information, the username, and the security token on a server for retrieval by and subsequent storage on the computing device at power-on of the computing device prior to providing the computing device to the user;
sending the security token to the username for entry by the user after configuration and registration of the operating system at the first user power-on of the computing device.

15. The non-transitory computer-readable data storage medium of claim 14, wherein the user is prompted for the configuration information incident to a procurement process initiated by the user in relation to the computing device.
